(19) United States
(12) Patent Application Publication
(10) Pub. No.: US 2021/0084877 A1
(43) Pub. Date: Mar. 25, 2021

(54) FISHING HOOK STORAGE ASSEMBLY AND METHOD(S) OF USE THEREOF

(71) Applicant: Roberto Antonio Ogarrio, Durango, CO (US)

(72) Inventor: Roberto Antonio Ogarrio, Durango, CO (US)

(21) Appl. No.: 16/576,008

(22) Filed: Sep. 19, 2019

(51) Int. Cl. A01K 97/06

(52) U.S. Cl. CPC A01K 97/06

(57) ABSTRACT

A fishing hook storage assembly is described. Embodiments of the fishing hook storage assembly can include, but are not limited to, a hook member and an attachment member magnetically coupled to each other. The hook member can be implemented to receive one or more hooks therein and magnetically couple to the hooks. The attachment mechanism can be implemented to couple the fishing hook storage assembly to an object.

### BACKGROUND

Currently, tackle boxes, segmented containers, and the like are used to store fishing lures. By keeping the fishing lures in a closed container, the hooks of the lures can be safely stored such that a user will not come into contact with them when not in use. These containers can be relatively small for fly fishing so as to be carried on the fisherman. Large tackle boxes can be used in other types of fishing where the lures and accompanying equipment is larger. Although these devices are useful for their intended purpose, their shape, size, and operation do not allow fisherman to easily view and/or retrieve lures while fishing. More specifically, when implementing containers to store fishing lures, a user will need to rummage through the container to find a particular lure all the while making sure they do not stab themselves with a hook of a lure.

Various contraptions have been conceived to allow a fisherman to easily access fishing lures while fishing. Each of the contraptions work for an intended purpose, but similar to fishing lure containers, they have limitations. The biggest limitation of most currently available contraptions is that they require a fisherman to interact with hooks on the lure.

One currently available device provides a bonnet for a treble fishing hook. To secure the treble hooks in the bonnet, the hooks are passed by locking inner protrusions (e.g., semi-spheres) to hold the treble hook in place. Once the treble hook is locked in place at a bottom of the hook bonnet, to remove the treble hook becomes very hard. A user has to push the bonnet device down from a top of the bonnet with their fingers, and when the treble hook snaps loose, the user is often stabbed on the finger(s). The bonnet may provide safety when the bonnet is on the treble hooks, but when the bonnet needs to be removed, the process is very dangerous and can be harmful to a user.

A fishing hook storage assembly is needed that can effectively store fishing lure hooks while providing easy access to the lures and provide protection from the hooks of the lures when interacting with the lure.

### BRIEF DESCRIPTION OF THE DRAWINGS

FIG. 1 is a side view of a fishing hook storage assembly according to one embodiment of the present invention.

FIG. 2 includes top views of several different fishing hook storage assemblies according to various embodiments of the present invention.

FIG. 3 is a side view of a fishing hook storage assembly storing a fishing hook according to one embodiment of the present invention.

FIG. 4 is a close-up view of a plurality of fishing hook storage assemblies and a fishing hook storage device coupled to a cord according to one embodiment of the present invention.

FIG. 5 is a close-up view of a fishing hook storage assembly coupled to a fishing rod according to one embodiment of the present invention.

FIG. 6 is a side view of a fishing hook storage device according to one embodiment of the present invention.

FIG. 7 is a side view of a fishing hook storage assembly including a cap according to one embodiment of the present invention.

FIG. 8 includes a variety of views of several different magnet shapes according to various embodiments of the present invention.

### DETAILED DESCRIPTION

Embodiments of the present invention include a fishing hook storage assembly and method(s) of use thereof. The fishing hook storage assembly can be implemented to store one or more fishing hooks and provide easy access to the stored fishing hooks. In one embodiment, the fishing hook storage assembly can include, but is not limited to, a hook member and an attachment member. The hook member and the attachment member can each include a magnet. The hook member magnet can magnetically couple to the attachment member magnet, thus allowing the hook member to be detached from the attachment member.

The hook member can be adapted to receive a hook (e.g., a hook by itself or a hook of a fishing lure) therein that may magnetically couple to the hook member magnet. The attachment member can be adapted to couple to another object while magnetically coupling to the hook member. Of note, a fishing lure coupled to the hook member can be located proximate the object the attachment member couples to.

In a typical implementation, a user may store a hook in the hook member that is coupled to an object on a body of the user. When the hook is needed, the user may remove the hook member from the attachment member, so as not to subject the user to the point and barb of the hook, while the user may tie the hook or lure to a fishing line. Once the hook is in place, the user may remove the hook from the hook member and reattach the hook member to the attachment member.

In one example implementation, the attachment member can be coupled to a necklace being worn by a fisherman. The fisherman may then place a hook, or hooks, of a fishing lure into the hook member where the hook may magnetically couple to the hook member magnet. The fisherman may then couple the hook member to the attachment member such that the fishing lure is readily available to the fisherman. The fishing lure can be effectively stored by the fishing hook storage assembly until a fisherman needs the lure.

In another example implementation, the fishing hook storage assembly can be used while retrieving a live fish. For instance, while a fisherman is extracting one of multiple lure hooks from a live fish, which is likely moving very erratically in all directions, the fisherman may quickly install a hook member to loose hooks of the lure to avoid impaling (or stabbing, or piercing) their fingers with the hooks and also the fish.

The fishing hook storage assembly may further include a cap. The cap can be implemented to couple to the first member and cover an opening of the receptacle. As can be appreciated, the cap can be implemented to enclose hooks stored within the receptacle. In some instances, the cap may be implemented to cover hooks when they are not in use and being stored until a later time.

In one embodiment, a point and a barb of a hook can be inserted at least a ¹/₄ inch into the receptacle of the hook member. Of note, a shank and an eye of the hook can extend beyond the hook member opening. As can be appreciated, this can allow a fisherman to easily grab and end of the hook for removal from the hook member.

The plastic bottom of the hook member can include an embedded strong magnet. The magnet can be protected by a very thin film of plastic on a top and bottom of the magnet (e.g., all around) between interfacing with a hook and the attachment member. The plastic covering film can be thin enough to allow good magnetic attraction and at the same time can provide a good and durable encasement and impermeable protection for the magnet.

In one embodiment, a north pole of the hook member magnet can be facing up from a bottom of the hook member so as to attract a hook(s) and magnetically couple to the hook. In such an embodiment, the attachment member magnet in the attachment member can have a south pole facing towards the attachment mechanism and a north pole of the attachment member magnet facing the hook member. Of note, when the two magnets are coupled together, an overall magnetic force of the magnets can increase. Thus, the coupled magnets can hold the hooks in place with a stronger force.

Embodiments of the present invention may further include a fishing hook storage device. The fishing hook storage device can be implemented similarly to the fishing hook storage assembly. The fishing hook storage device can include, but is not limited to, a body, a receptacle, a cavity, a magnet, and a coupling mechanism. The magnet can be stored in the cavity and the receptacle can be configured to receive a fishing hook therein. In some embodiments, a cap can be implemented to cover the receptacle of the fishing hook storage device. The coupling mechanism can be implemented to couple the fishing hook storage device to an object.

Embodiments of the present invention may further include a system including one or more of the fishing hook storage assemblies and one or more of the fishing hook storage devices used in combination.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment”, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “cord” as used in this specification and the appended claims, refers to, but is not limited to, rope, chains, cordage, string, lanyard, twine, and cable.

### An Embodiment of Fishing Hook Storage Assembly

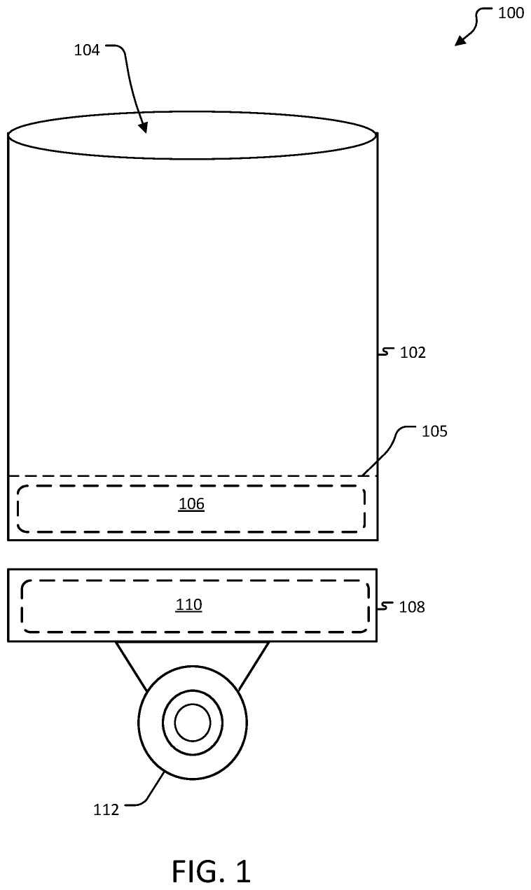

Referring to FIG. 1, a detailed diagram of an embodiment 100 of a fishing hook storage assembly is illustrated. The fishing hook storage assembly 100 can be implemented to provide quick access and storage for fishing hooks. Cordage, necklaces, bracelets, etc. can be implemented to couple to the fishing hook storage assembly 100. Typically, the cordage can be worn by a user. As can be appreciated, fishing hooks being stored by the fishing hook storage assembly 100 can be readily accessed by a user wearing the cordage.

As shown in FIG. 1, the fishing hook storage assembly 100 can include, but is not limited to, a first member 102 and a second member 108. The first member 102 can be implemented to store a hook and the second member 108 can be implemented to attach (or couple) to an object. The hook member 102 can include a first magnet 106 and the attachment member 108 can include a second magnet 110. The hook member magnet 106 can be implemented to magnetically and removably couple to the attachment member magnet 110.

The hook member 102 can typically have a tubular structure and include a receptacle 104. A first end of the hook member 102 can form an opening for the receptacle 104. The first magnet 106 can be located proximate a second end of the hook member 102. In some embodiments, a pocket (or cavity) 105 at the second end of the hook member 102 can be formed to house the first magnet 106 therein. In another embodiment, the first magnet 106 can be embedded in the hook member 102. For instance, the hook member 102 may be manufactured from a thermoplastic and the first magnet 106 may be embedded in the thermoplastic during production. The hook member 102 can be implemented to receive a hook (or hooks) of a fishing lure in the receptacle 104. The hook member magnet 106 can be implemented to magnetically couple to hooks of fishing lures.

Generally, a fishing lure hook can be placed into the hook member 102 and then magnetically couple to the hook member magnet 106. By implementing the hook member magnet 106, a user can quickly and efficiently secure a fishing lure to the hook member 102. Of note, a user can easily remove the fishing lure from the hook member 102 by simply grabbing the fishing lure and pulling the hook away from the magnet 106. In another instance, the user may decouple the hook member 102 from the attachment member 108 with the hook remaining in the hook member 102.

The attachment member 108 can include a coupling mechanism 112 for securing to another object. In one example, as shown in FIG. 1, the coupling mechanism 112 may be an eyelet for receiving cordage therethrough. It is to be appreciated that other coupling mechanisms are contemplated and can be implemented in place of the eyelet. For example, a clip may be implemented. In another example, the coupling mechanism 112 may be a part of a snap button that is adapted to couple to another part of the snap button on a piece of clothing or clothing accessory. In yet another example, the coupling mechanism 112 may include a hook and loop fastener.

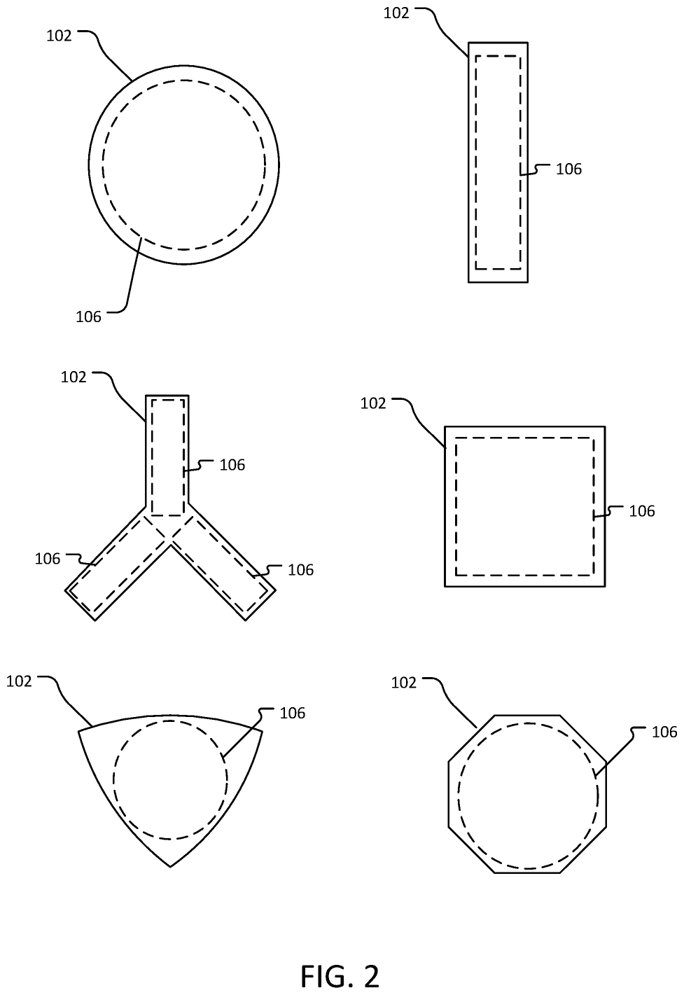

Referring to FIG. 2, top views of several different shapes of the hook member 102 are illustrated. As shown, the hook member 102 may have a circular shape, a rectangular shape, a triangular shape, a square shape, an octagonal shape, or a reuleaux triangular shape. It is to be appreciated that other shapes not explicitly shown are contemplated and not outside a scope of the present invention. Generally, the hook member magnet 106 can be shaped similar to a shape of the hook member 102. In one example, with the triangular shaped hook member 102, three rectangular magnets 106 may be implemented.

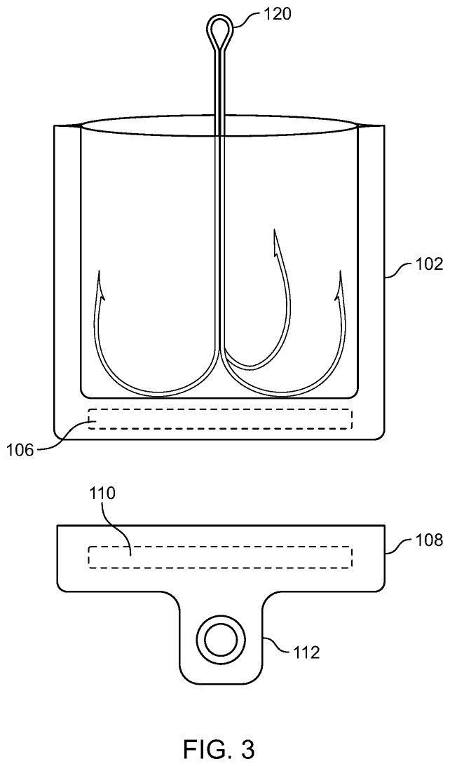

Referring to FIG. 3, a side view of the fishing hook storage assembly 100 storing a hook 120 is illustrated. As shown, the hook 120 can be inserted into the receptacle 104 and can magnetically couple to the first magnet 106. Typically, a point and a barb of the hook 120 can be inserted fully into the receptacle 104 of the hook member 102 leaving a portion of a shank and eyelet outside the hook member 102. The hook member 102 can be decoupled from the attachment member 108 allowing a user to keep the point and barb of the hook 120 protected while tying a line to the hook 120. By implementing the first magnet 106 and the second magnet 110, the fishing hook assembly 100 can ensure that the hook 120 remains coupled to the hook member 102 even when the hook member 102 is decoupled from the attachment member 108.

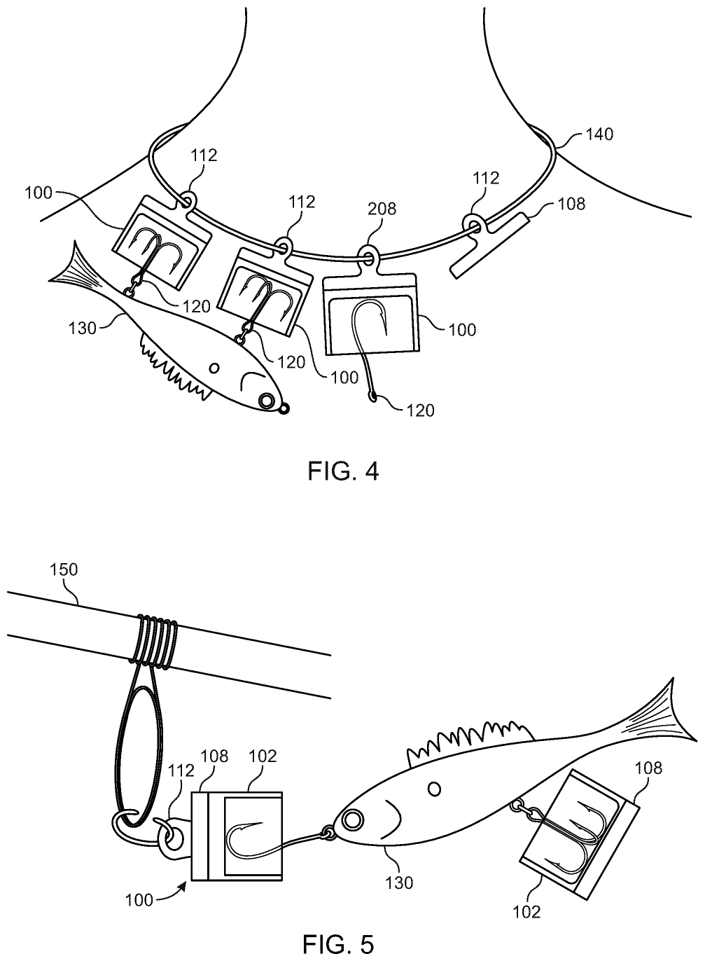

Referring to FIG. 4, a plurality of hook members 102 and attachment members 108 are shown with a fishing lure 130 and a cord 140. As shown, the attachment members 108 can be coupled to the cord 140 via the coupling mechanism 112. The fishing lure 130 can include a pair of hooks, with each hook being inserted into a fishing hook storage assembly 100. When a user wants to user the fishing lure 130, the user can decouple the pair of hook members from the attachment members and tie the lure to a fishing line. As shown, the fishing lure 130 can be readily available to the user and provide protection from the points and barbs of the hooks of the lure 130 while the user may tie the fishing lure 130 to a fishing line. Further shown is a hook 120 being stored for later use. A single attachment member 108 is shown coupled to the cord 140 and ready to couple to a hook member when needed. For instance, a user may cut a currently used fishing lure from a fishing line and place a hook of the fishing lure in the detached hook member. The user may then couple the hook member, with inserted hook, to the vacant attachment member 108 for storage before using the other fishing lure. Of note, one or more fishing hook storage assemblies 100 can be implemented by a fisherman as needed.

Referring to FIG. 5, a fishing hook storage assembly 100 being used with a fishing rod 150 is illustrated. In this figure, the attachment member 108 is shown being coupled to a guide of the fishing rod 150. In this embodiment, an additional coupling mechanism may be implemented to couple the attachment member 108 to the guide of the rod 150. Of note, in some embodiments, the attachment member 108 may include a coupling mechanism configured to couple to the guide. Of significant note, by implementing the fishing hook storage assembly 100 to couple to the fishing rod 150, the hook of the fishing lure 130 can be protected. This may be important when using expensive lures or older lures that are prone to breaking, scratching, or decaying when interfacing with a rigid object. Further, a bend of the hook of the fishing lure 130 can be kept intact by not applying a force directly to the hook as typically happens when the hook interfaces directly with the guide of the fishing rod 150. Of note, it is a common practice to keep a fishing lure attached to a fishing line most of the time. When the fishing lure is not in use, the lure can be reeled in and attached to an eyelet on the fishing pole. By placing the protective hook member 102 on the lure, the hook(s) will be contained and they will not get caught or hooked to anything.

### An Embodiment of a Fishing Hook Storage Device

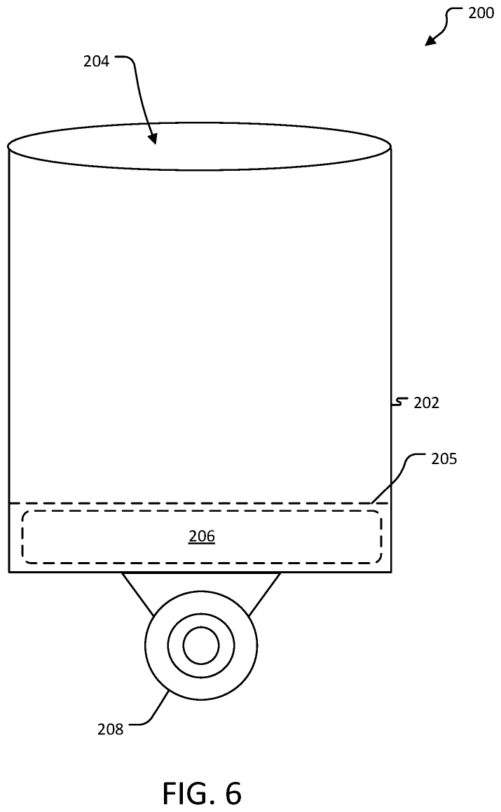

Referring to FIG. 6, a detailed diagram of an embodiment 200 of a fishing hook storage device is illustrated. The fishing hook storage device 200 can be implemented similar to the fishing hook storage assembly 100. More specifically, the storage device 200 can be implemented to store hooks from fishing lures or fishing hooks themselves.

As shown in FIG. 6, the fishing hook storage device 200 can include, but is not limited to, a body 202, a receptacle 204, a cavity 205, a magnet 206, and a coupling mechanism 208. The receptacle 204 can be implemented to receive a fishing hook therein. The cavity 205 and can be implemented to house the magnet 206 therein. The magnet 206 can be implemented to magnetically couple to a fishing hook, similar to the first magnet 106 of the first embodiment fishing hook storage assembly 100. The coupling mechanism 208 can be implemented to couple to an object. Typically, the object can be on a person or bag a person is carrying while fishing. For instance, the object may be a cord being worn by a fisherman or a cord on a bag being worn by the fisherman.

In one example embodiment, as shown, the coupling mechanism 208 may be an eyelet reinforced with a washer. It is to be appreciated that other coupling mechanisms can be implemented without exceeding a scope of the present inventions. For instance, a clasp may be implemented. In another instance, the coupling mechanism 208 may be a carabiner. In yet another instance, the coupling mechanism 208 may be part of a hook and loop fastener.

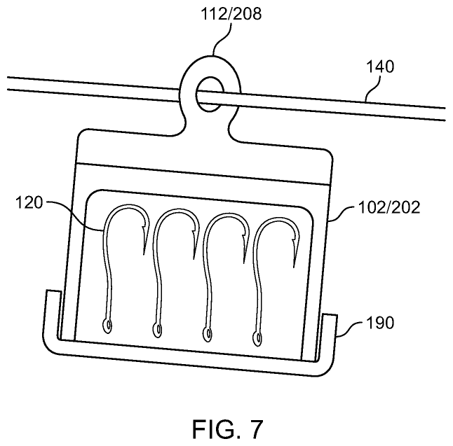

Referring to FIG. 7, the fishing hook storage assembly 100 and/or the fishing hook storage device 200 being coupled to a cord 140 and storing a plurality of hooks 120 is shown. In some embodiments, a cap 190 can be implemented with the fishing hook storage assembly 100 and/or the fishing hook storage device 200. As shown, the cap 190 can be implemented to cover the hooks 120 located in the receptacle of the fishing hook storage assembly 100. In one instance, the cap 190 can friction fit over the first member 102 (or body 202). It is to be appreciated that other means of coupling the cap 190 to the first member (or body 202) are contemplated and not outside a scope of the present disclosure.

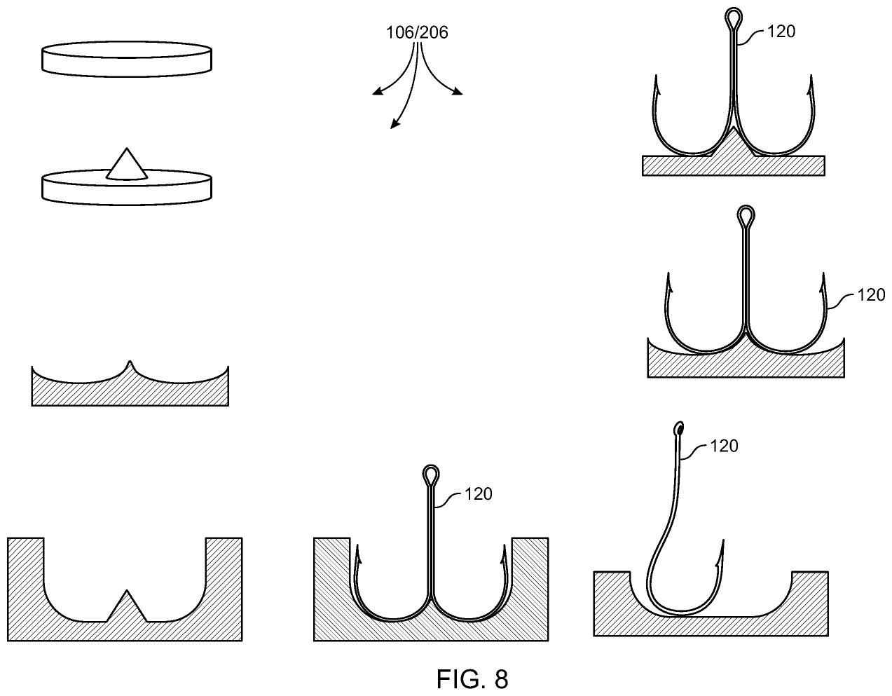

Referring to FIG. 8, a plurality of differently shaped magnets are illustrated. The differently shaped magnets can be implemented as the hook member magnet 106 and/or the fishing lure storage device magnet 206. In one instance, the magnet may have a substantially disc shape. An embodiment of the magnet 106/206 is contemplated where a conical protrusion may be included proximate a center of the magnet. As shown, the conical protrusion may extend up and interact with a shank of a hook. A cross-sectional view of another instance of the magnet having depressions for interfacing with a hook section of a fishing hooks is shown. A small protrusion proximate a middle of the magnet can allow for interaction with a shank portion of the fishing hook, as shown in the figure. The depressions may allow for more of the magnet of interact with the fishing hook. Another cross-sectional view of yet another instance shows a U-shaped magnet including a conical protrusion proximate a middle and bottom of the U. As shown, this style of magnet may interface with hook portions and a shank of a multi-hook fishing hook. The sides of the U can provide maximum magnetic coupling to the hook sections of the fishing hook. In another instance, the magnet may have a substantially U-shape. As shown, the hook portion of the fishing hook may interface with a side and bottom of the magnet.

Referring back to FIG. 4, a fishing lure storage device 200 is shown coupled to the cord 140 being worn by a user. Of note, a system is contemplated wherein one or more fishing lure storage assemblies 100 are used in combination with one or more fishing lure storage devices 200.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A fishing hook storage assembly comprising:
a first member, the first member including:
a receptacle;
a first magnet located on a bottom of the receptacle; the first magnet adapted to magnetically couple to a hook;
a second member, the second member including:
a coupling mechanism adapted to couple to an object;
a second magnet, the second magnet adapted to magnetically couple to the first magnet;
wherein the first member is removably coupled to the second member.

2. The fishing hook storage assembly of claim 1, wherein the receptacle is sized to receive at least a point and a barb of a hook.

3. The fishing hook storage assembly of claim 1, wherein the first member has a substantially cylindrical shape.

4. The fishing hook storage assembly of claim 1, wherein the first member has a substantially rectangular shape.

5. A method of implementing the lure storage assembly of claim 1, the method comprising:
coupling the lure storage assembly to an object via the second member;
detaching the first member from the second member;
inserting a hook into the first member until the hook is magnetically coupled to the first magnet; and
attaching the first member to the second member.

6. The fishing hook storage assembly of claim 1, wherein the first magnet is adhesively bonded to the receptacle.

7. The fishing hook storage assembly of claim 1, wherein the first magnet is secured in a cavity of the receptacle.

8. The fishing hook storage assembly of claim 1, wherein the second member is defined by:
a cavity for storing the second magnet therein; and
an eyelet protruding from the cavity, the eyelet adapted to receive a cord therethrough.

9. The fishing hook storage assembly of claim 1, wherein the first member and the second member are manufactured from plastic.

10. The fishing hook storage assembly of claim 1, wherein the assembly further includes:
a cap adapted to couple to the first member and cover the receptacle.

11. A fishing hook storage system comprising:
a cord adapted to be worn on a person;
a plurality of attachment members coupled to the cord, each of the plurality of attachment members including:
a magnet; and
an attachment mechanism for coupling to the cord;
a plurality of hook members, each of the plurality of hook members including:
a magnet for magnetically coupling to (i) one of the attachment member magnets, and (ii) a hook; and
a receptacle including a first end and a second end, the first end including the magnet and the second end being open to receive a hook therein.

12. The system of claim 11, wherein a first hook member has a substantially cylindrical tube shape and a second hook member has a substantially rectangular tube shape.

13. The system of claim 12, wherein each of the plurality of attachment members have a substantially cylindrical tube shape.

14. The system of claim 11, wherein each of the attachment mechanisms are an eyelet.

15. The system of claim 11, wherein a north pole of each of the magnets for the plurality of hook members are adapted to magnetically couple to a hook.

16. The system of claim 15, wherein a south pole of the magnets for the plurality of hooks members are adapted to magnetically couple to a north pole of the magnets for the plurality of attachment members.

17. The system of claim 11, wherein the attachment mechanisms are removably coupled to the cord.

18. The system of claim 11, wherein the attachment mechanism of a first attachment member is an eyelet and the attachment mechanism of a second attachment member is a hook and loop fastener.

19. The system of claim 18, wherein the attachment mechanism of a third attachment member is a clasp.

20. A fishing hook storage assembly comprising:
a first member, the first member including:
a receptacle;
a first magnet located on a bottom of the receptacle; the first magnet adapted to magnetically couple to a hook;
a second member, the second member including:
a coupling mechanism adapted to couple to an object;
a second magnet, the second magnet adapted to magnetically couple to the first magnet;
a cap adapted to be removably coupled to the first member, the cap covering the receptacle when coupled to the first member;
wherein the first member is removably coupled to the second member.
